(19) United States
(12) Patent Application Publication
(10) Pub. No.: US 2003/0226119 A1
(43) Pub. Date: Dec. 4, 2003

(54) Integrated circuit design of a standard access interface for playing compressed music

(76) Inventors: Chi-Tung Chang, Taipei (TW); Ming-Te Tseng, Chung-Ho City (TW); Shih-Hsien Yang, Chung-Ho City (TW); Li-Wei Wang, Yung-Ho City (TW)

Correspondence Address: Alcor Micro, Corp., P.O. Box No.6-57, Chung-Ho, Taipei, 235, TW

(21) Appl. No.: 10/155,727

(22) Filed: May 28, 2002

(51) Int. Cl. G06F 17/50

(52) U.S. Cl. 716/1; 716/2; 716/3

(57) ABSTRACT

An integrated circuit design of a standard access interface for playing compressed music includes a connectivity access interface capable of respectively connecting with a fixed media storage, such as a computer, or a movable media storage, such as a portable disk or flash memory; furthermore, when connected with the fixed media storage, a media player processor executes the access function of a standard connectivity interface of a mass storage class flash memory card thereby allowing free access to data or compressed music data in various formats in the fixed media storage and the moveable media storage via the standard access for mass storage class.

### BACKGROUND OF THE INVENTION

1) Field of the Invention

The present invention relates to an integrated circuit design of a standard access interface for playing compressed music, more especially to an integrated circuit design that allows hardware to use standard access interface to freely read and access any data format and to play compressed music.

2) Description of the Prior Art

Accordingly, the conventional method of playing compressed music mainly incorporates a flash memory element as the main data storage component; the technique thereof stores the compressed music data onto a flash memory card in a proprietary format and plays music by a player hardware using a proprietary player program. When it is connected to a fixed media storage such as a computer, this type of player hardware can only be used for playing compressed music but not directly be used as a moveable read device for easy storage of variously formatted data files; that limits the function of a flash memory to only for storing the compressed music data files thereby wasting the mass media storage resource.

Furthermore, to the user, the conventional compressed music player device and player technology thereof, the player hardware is limited to its functions and the flash memory card is limited in the scope of its applications; if the user needs to access larger capacity compressed music data files, various types of flash memory card reader separately coupled with their respective types of flash memory cards must be used to connect with media storage such as a computer that has mass file transport function. In other words, an extra card reader hardware device must be added before the large quantity of data or files in the flash memory can be stored; that not only increases the inconvenience of application and operation, but also fails to be economical.

### SUMMARY OF THE INVENTION

Therefore, the primary objective of the present invention is to provide an integrated circuit design of a standard access interface for playing compressed music, wherein a media player processor via a standard access interface may execute the functions of a mass storage class card reader and to access various types of files in a flash memory or to function as a standalone compressed music data player device.

Another objective of the present invention is to provide an integrated circuit design of a standard access interface for playing compressed music comprising a host system connectivity interface and a multimedia storage interface to respectively connect with a fixed media storage and a movable media storage; therefore, the media player processor allows the option of storing mass quantity of variously formatted files or the compressed music data files onto the flash memory thereby fully utilizing the resource of the flash memory.

Yet another objective of the present invention is to provide an integrated circuit design of a standard access interface for playing compressed music allows the use of the same media player processor, the host system connectivity interface and the multimedia storage interface to execute the functions of the connected mass storage card reader or functions of a standalone compressed music data player without adding extra hardware.

To enable a further understanding of the technical methods and contents of the present invention, the brief description of the drawings below is followed by the detailed description of the preferred embodiment.

### BRIEF DESCRIPTION OF THE DRAWINGS

FIG. 1 is a block diagram of the circuit of the first implementation of the present invention.

FIG. 2 is a drawing of the second exemplary embodiment of the present invention.

FIG. 3 is a block diagram of the present invention executing the functions of a mass storage card reader device.

FIG. 4 is a block diagram of the present invention executing the function of a standalone compressed music player device.

### DETAILED DESCRIPTION OF THE PREFERRED EMBODIMENTS

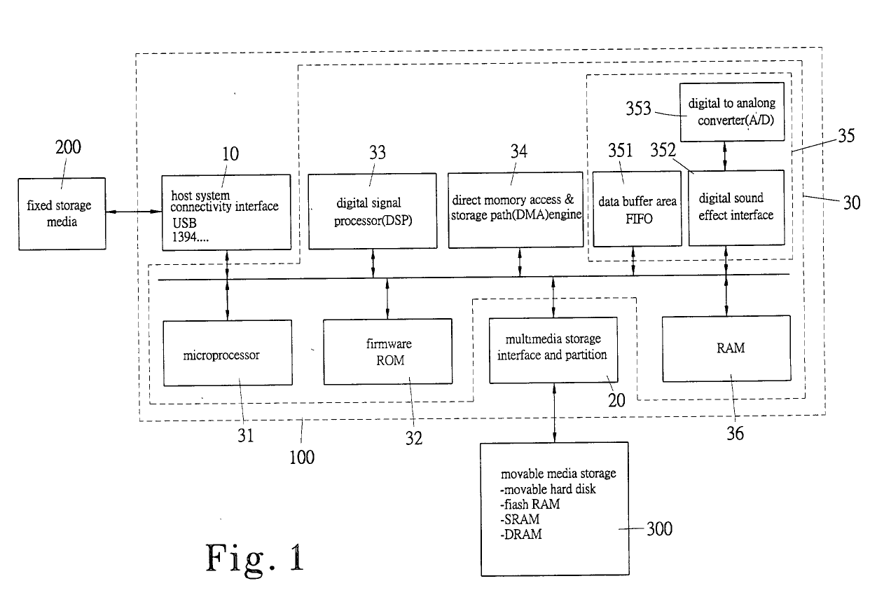

FIG. 1 shows the block diagram of the first implementation of the present invention, wherein an integrated circuit design of a standard access interface for playing compressed music is hereunder named player device and indicated by code 100 hereon. The player device (100) comprises a host system connectivity interface (10), a multimedia storage interface (20) and a media player processor (30), wherein the host system connectivity interface (10) connects with a fixed media storage (200), such as a standard USB or an IEEE1394 interface; the fixed media storage (200) is not limited in types as it can be a personal computer or other host computers; the multimedia storage interface (20) connects with a movable media storage (300), such as a flash memory interface; the movable media storage (300) also is not limited in types as it can be a portable disk drive, a flash RAM, an SRAM or a DRAM.

The abovementioned media player processor (30) comprises a microprocessor (31), a firmware micro processor system interface (32), a digital signal processor (33), a direct memory access path engine (34), a sound effect playing unit (35) and a RAM (36), wherein the microprocessor (31) and the firmware micro processor system interface (32) control all other circuits and use a regular disk drive partitioning system to perform read functions; which means the firmware micro processor system interface (32) contains a disk drive partitioning system that reads FAT formatted and standard USB mass storage class files and data.

The digital signal processor (33) processes the data decompression to allow data restore to be controlled by the microprocessor (31) and the firmware micro processor system interface (32).

The direct memory access path engine (34) connects and accelerates the access speed of the fixed media storage (200) or the movable media storage (300) respectively connected with the host system connectivity interface (10), the multimedia storage interface (20), so as to enhance the operation efficiency.

The sound effect playing unit (35) processes the sound effect playing of the music data converted from the decompression operated by the digital signal processor (33); it further comprises a FIFO data buffer (351), a digital sound effect interface (352) and digital to analog converter (353), wherein the FIFO data buffer (351) prevents sounds being played with discontinuous and intermittent effects; the digital sound effect interface (352) and the digital to analog converter (353) convert the digital sound effect signals into analog sound for output.

The Random Access Memory RAM (36) provides the microprocessor (31) the coding parameters and for temporary data storage.

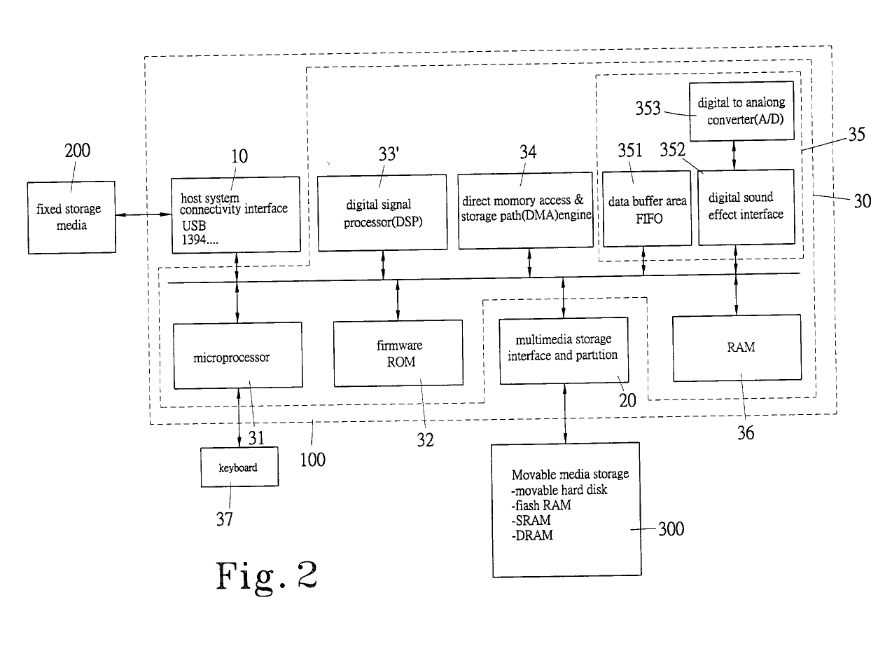

FIG. 2 shows the second exemplary embodiment of the present invention, wherein the difference between this implementation and that in FIG. 1 is that the digital signal processor (33) of the media player processor (30) is replaced by a math operating unit (33′); the circuit function of the math operating unit (33′) is the same as that of the digital signal processor (33) for executing the data decompression process. The microprocessor (31) externally connects with a keyboard (37) to allow play, pause, stop, forward or rewind functions be operated on the compressed music play list. The media player processor (30) externally connects with an independent power supplier (40) to provide independent power source when the compressed music sound effect is being played; the independent power supplier (40) is not limited in types and it is a battery of direct current adopted in the present invention for describing the exemplary implementation.

In FIGS. 1 and 2, the abovementioned the host system connectivity interface (10), the multimedia storage interface (20) and the media player processor (30) of the player device (100) are integrated as an integrated circuit on a single chip so as to allow overall reduced physical size.

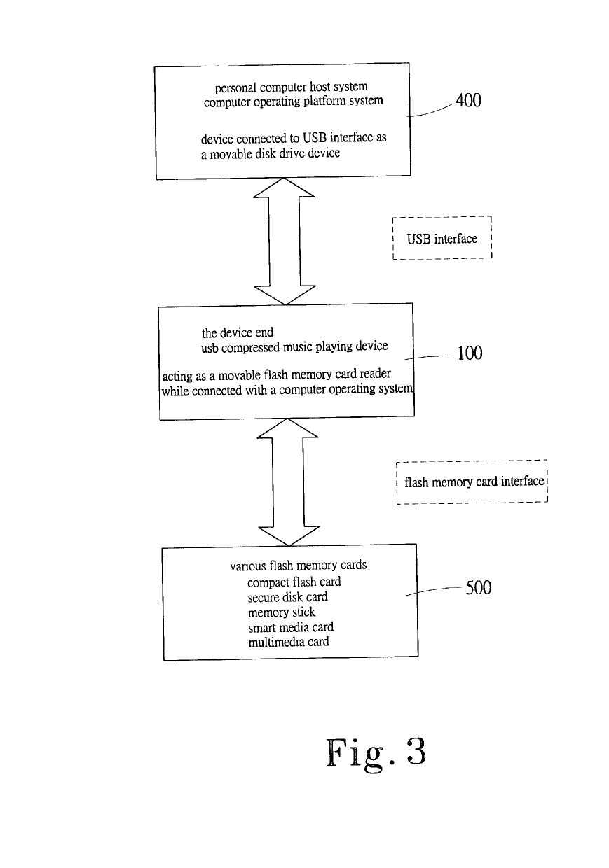

FIG. 3 shows the block diagram of the present invention executing the functions of a mass storage class card reader via a standard access interface, wherein the player device (100) connects with a host computer (400) through the host system connectivity interface (10) and connects with a flash memory card (500) through a multimedia storage interface (20); at this time, the media player processor (30) executes standard USB reader function; the program and steps of the operation thereof are described as follows:

When the player device (100) connects with the host computer (400), the microprocessor (31) and the firmware micro processor system interface (32), based on the memory storage capacity and format, take the entire media player processor (30) as an external USB card reader attached onto the host computer (400) and determine whether to conduct standard USB mass storage class data read and access function or not. The compressed music data or files wherein are treated as regularly formatted files and the data therein can be easily read, accessed or stored through a platform operating system in the host computer (400), such as the file management system functions of the Windows or MAC systems that allow easy read or access of data therein. The externally added flash memory card (500) may be formatted with a standard FAT file format and is applicable for mass data storage in any format.

The operating system of the host computer (400) provides the editing program or software for the compressed music data and play list; the operating system allows the order of the play list to be freely edited and saves the information and data onto the flash memory card (500) where it can be activated when the compressed music player functions are being performed alone.

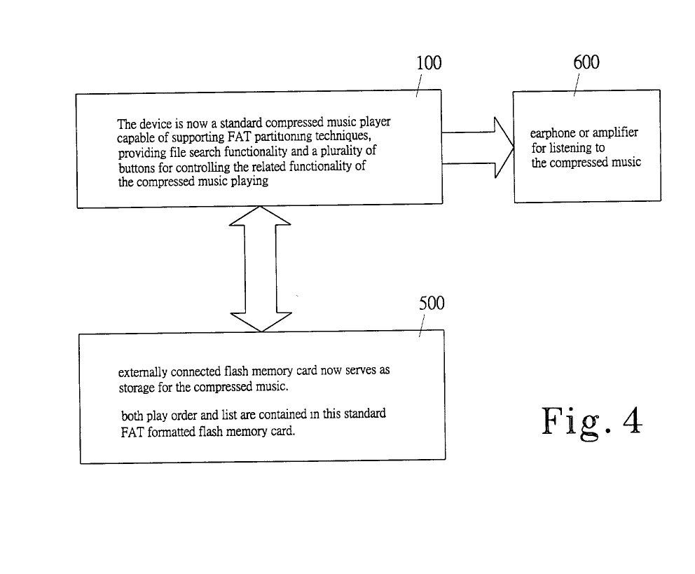

FIG. 4 shows the block diagram of the player device (100) of the present invention independently executing the function of playing the compressed music, wherein the host system connectivity interface (10) does not connect with the fixed media storage (200) or a host computer (400); only the flash memory card (500) connects with the player device (100) via the multimedia storage interface (20); at this time, the microprocessor (31) and the firmware micro processor system interface (32) recognize the media player processor (30) as a standalone compressed music player that executes the function of playing the compressed music. The procedure and detailed functions thereof are described as follows:

The player device (100) uses the independent power supplier (40), as shown in FIG. 2, as the power source for playing the sound effect of the compressed music as an independent operation.

The player device (100) uses the FAT file system via the firmware micro processor system interface (32) to automatically search for the play list saved on the flash memory card (500) to establish play order.

The player device (100) uses the keyboard (37), as shown in FIG. 2, to allow the play, pause, stop, forward and rewind functions to be performed when playing the compressed music.

The digital signal processor (33) or the math operating unit (33′) conducts the process of decompressing the compressed music data saved on the flash memory card (500).

The FIFO data buffer (351), the digital sound effect interface (352) and the digital to analog converter (353) of the sound effect playing unit (35) convert the digital sound effect data decompressed by the digital signal processor (33) or the math operating unit (33′) into analog sound effect for playing, that means, the sound effect is transmitted to a player element (600) via the digital to analog converter (353).

It is of course to be understood that the embodiment described herein is merely illustrative of the principles of the invention and that a wide variety of modifications thereto may be effected by persons skilled in the art without departing from the spirit and scope of the invention as set forth in the following claims.

1. An integrated circuit design of a standard access interface for playing compressed music comprising:
a host system connectivity interface connects with a fixed media storage;
a multimedia storage interface connects with a movable media storage;
a media player processor connects with the fixed media storage or the movable media storage through the host system connectivity interface and the multimedia storage interface respectively and comprises a microprocessor, a fixed media storage and the movable media storage, a digital signal processor and a sound effect unit; the micro processor and the firmware micro processor system interface may determine, via storage capacity and the types of data format, the connection of the fixed media storage or moveable media storage, or the connectivity status of standard moveable media storage; when both the fixed media storage and the movable media storage are present, the firmware micro processor system uses the standard access interface of a mass storage class to access variously formatted data in fixed media storage as well as in moveable media storage; when the movable media storage exists individually, the firmware micro processor system interface uses the FAT data format to make the digital system process interface decompress the compressed music data stored in the movable media storage and the sound effect playing unit converts the decompressed music data into analog sound effect for transmission.

2. The integrated circuit design of a standard access interface for playing compressed music according to claim 1, wherein the fixed media storage that is connected with the host system connectivity interface is a host computer

3. The integrated circuit design of a standard access interface for playing compressed music according to claims 1 and 2, wherein the host system connectivity interface is a standard USB connectivity interface of a standard access interface.

4. The integrated circuit design of a standard access interface for playing compressed music according to claims 1 and 2, wherein the host system connectivity interface is a standard IEEE 1394 connectivity interface of a standard access interface.

5. The integrated circuit design of a standard access interface for playing compressed music according to claim 1, wherein the movable media storage connects with the multimedia storage interface is a flash memory card.

6. The integrated circuit design of a standard access interface for playing compressed music according to claim 1, wherein the multimedia storage interface is a flash RAM interface.

7. The integrated circuit design of a standard access interface for playing compressed music according to claim 1, wherein the media player processor further comprises a direct memory access path engine to connect with the host system connectivity interface and the multimedia storage interface for accelerating data access and storage.

8. The integrated circuit design of a standard access interface for playing the compressed music according to claim 1, wherein the media player processor comprises a RAM for connecting with a storage microprocessor to provide coding parameters and data transmission.

9. The integrated circuit design of a standard access interface for playing compressed music according to claim 1, wherein the microprocessor of the media player processor externally connects with a keyboard.

10. The integrated circuit design of a standard access interface for playing compressed music according to claim 1, wherein the sound effect playing unit of the media player processor comprises a FIFO data buffer unit, a digital sound effect interface and a digital to analog converter.

11. The integrated circuit design of a standard access interface for playing compressed music according to claim 1, wherein the host system connectivity interface, the multimedia storage interface and the media player processor are integrated as an integrated circuit on a single chip for implementation.
